(19) United States
(12) Patent Application Publication
(10) Pub. No.: US 2010/0292352 A1
(43) Pub. Date: Nov. 18, 2010

(54) PREPARATION AND APPLICATION OF CHAIN-EXTENDING CONCENTRATES FOR POLYESTER FOAMING PROCESS

(75) Inventors: Jie LI, Zofingen (CH); Horst GRATER, Muenster (DE); Mika MELLER, Veikkola (FI)

Correspondence Address: ROTHWELL, FIGG, ERNST & MANBECK, P.C., 1425 K STREET, N.W., SUITE 800, WASHINGTON, DC, 20005, US

(73) Assignee: ARMACELL ENTERPRISE GMBH, Muenster (DE)

(21) Appl. No.: 12/782,338

(22) Filed: May 18, 2010

(30) Foreign Application Priority Data
May 18, 2009 (EP) 09006678.8

(51) Int. Cl. C08J 11/04; C08J 9/00; C08F 8/00; C08L 33/08; C08F 8/40; C08F 8/14

(52) U.S. Cl. 521/48; 521/81; 525/55; 525/194; 525/340; 525/375; 525/379; 525/384; 525/385; 525/386

(57) ABSTRACT

The composition and the preparation of a chain-extending concentrate for production of foamed cellular materials of aromatic polyesters is disclosed in this invention. The chain-extending concentrate includes an ethylene-acrylate copolymer, a high-temperature thermoplastic and a multifunctional compound. The preparation process includes two steps: 1) Mixing and melt blending the multifunctional compound and the HT thermoplastic resin into the matrix of the ethylene-acrylate copolymer in an internal mixer and 2) extrusion of the mixture at a temperature below the melting point or reaction temperature of the multifunctional compound.

### BACKGROUND OF INVENTION

Aromatic polyester foams, particularly foamed materials based on PET and PBT resins, are nowadays more and more produced by implementing a reactive foam extrusion comprising upgrading or improvement of molecular weight and extensional viscosity of aromatic polyester resins during the extrusion process. Often preferred are multifunctional compounds comprising multifunctional tretracarboxylic dianhydrides acting as chain-extenders.

The European Patent EP 08016250 discloses:
1) That the antioxidant comprising sterically hindered phenolic end groups in combination with tetracarboxylic dianhydride results in a significant increase of molecular weight of polyester during the heating and mixing process, as such a mixture also enhances the extensional viscosity of polyester remarkably.
2) Furthermore, addition of an oxazoline into a mixture comprised of sterically hindered phenolic antioxidant and tetracarboxylic dianhydride leads to an dramatic upgrading of polyester melt within a certain time frame during the thermal and mixing process and the extensional viscosity of polyester melt remained high and
3) Concentrates of this formulation comprised of sterically hindered phenolic antioxidant, tetracarboxylic dianhydride and oxazoline can be used for foam extrusion of polyesters. It has been surprisingly discovered in EP 08016250 that addition of such concentrates into a twin screw extruder improves the extrusion process. By applying oxazoline, an improvement of mechanical stiffness, a better isotropy of foam extrudates and an increase in extrusion throughput are expected. Besides, the cell structure of polyester foam modified by oxazoline is further improved and very fine cells could be obtained.

To reduce or eliminate the instability problems of said reactive foam extrusion, use of a concentrate (masterbatch) recommended for example by EP 08016250, U.S. Pat. No. 5,288,764, WO 9509884, and EP 0801108, obtained by melt blending the multifunctional chain-extending/branching compound containing tetracarboxylic dianhydride and a carrier polymer, is mostly preferred. The concentrate is then mixed at given levels with the polyester in an extruder (preferably twin-screw extruder) to let aromatic polyester resin foamed in a stable process.

The melting point of some applied chain-extending ingredients is, however, lower than the carrier materials or below/within temperature range of preparation process. A list of such ingredients used in examples of EP 08016250, U.S. Pat. No. 5,288,764, WO 9509884, and EP 0801108 is written in Tab. 1:

TABLE 1
Melting point of ingredients

| Ingredient | Melting point (° C.) |
|---|---|
| PMDA | 286.0-287.5 |
| Irganox 1330/Ethanox 330 | 240.0-245.0 |
| 1,3-PBO | 145.0-147.0 |

Due to the fact that ingredients might be already, at least partially, molten in the preparation process of concentrates, a production of such masterbatches is difficult, if not impossible. The efficiency of made concentrates may be impaired because of the unwished chemical reaction during production of said concentrates. On the other hand, choice of inappropriate carrier materials may lead to troubles at or even interruption of a reactive foam extrusion production. Related to both facts, following problems can occur if preparing the concentrates according to U.S. Pat. No. 5,288,764, WO 9509884, and EP 0801108:

U.S. Pat. No. 5,288,764 discloses a concentrate comprising PET as carrier material and pyromellitic dianhydride as the multifunctional compound, which is used in the reactive extrusion process of PET foaming. The concentrate is obtained by mixing PMDA in molten PET at temperatures as high as 280-300° C., wherein PET molecular branching and gel formation take place during this melt blending process. The high processing temperature necessary for compounding of the ingredient can result in sublimation of PMDA at the extruder head. Such problems cause an instable foaming process and inconsistent foam quality.

Application of PC as carrier material as described in EP 0801108 leads similarly to above problems: A molecular branching of polycarbonate and gel formation occurs. A sublimation of PMDA caused by high processing temperature and additionally by sticking problems of PC is inevitable at the extruder head. It has been found that a concentrate containing PC as carrier material is not able to provide a continuously stable foaming process. In addition, the cell structure of produced foam products is mostly not uniform.

Another type of masterbatch is obtained according to WO 9509884 by melt blending 1 to about 50 wt % of multifunctional carboxylic anhydrides in 50 to 99 wt % of molten polyolefin. The concentrate is subsequently applied in the polyester foaming process at a high temperature (280-300° C.), at which polyolefin tends to degradation. In worst case, the degradation of polyolefin causes a dramatic pressure decrease in extruder and die, so that the blowing agent can not remain in the polyester melt and no foaming is possible. The relatively low softening and melting point of polyolefin (LDPE used in examples of WO 9509884 has for instance a melting point around 110° C.) and the relatively high drying temperature of PET (normally at a temperature of 110-165° C.) can not guarantee a stable and continuous foaming process: 1) Drying of this masterbatch containing high-percentage of polyolefin is not easy due to stickiness and bridging problems caused by the low softening point of polyolefin and 2) A direct contact of the dried PET with said concentrate before melting zone softens and even melts the concentrate, this results in blocking of the feeder, hopper or even the feeding zone of the extruder, followed by an instable process or even an interruption of the extrusion production. Furthermore, due to a poor compatibility between polyolefin and polyester, an instable foaming process and inhomogeneous cell structure result from a poor dispersion of the ingredient and possible active nucleation sites within the polyester melt.

### SUMMARY OF THE INVENTION

To solve/eliminate the problems mentioned above, a new type of concentrate containing multifunctional compound acting as chain-extenders/branchers has been developed. The new concentrate is able to perform a stable foaming process comprising a process chain from drying to extrusion and allows a mass production of cellular foamed materials of polyesters with fine, uniform and consistent cell structure.

### BRIEF DESCRIPTION OF THE DRAWINGS

FIG. 1 formulaically represents a) Ethylene Butyl Acrylate (EBA), b) Ethylene Ethyl Acrylate (EEA) and c) Ethylene Methyl Acrylate (EMA).

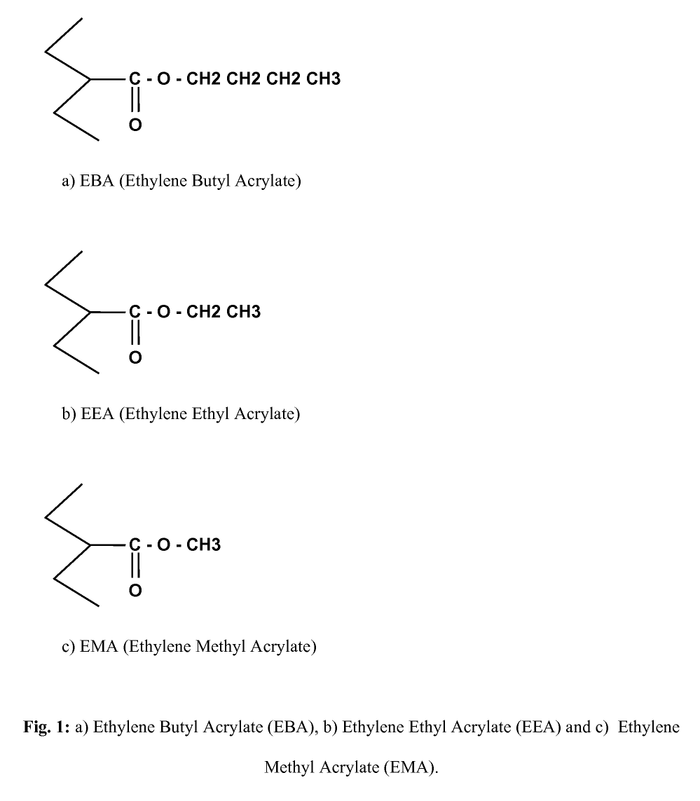

### 1. DESCRIPTION OF INVENTION

In the current invention, it has been found that it is possible to obtain a masterbatch which ensures a stable foaming process without problems mentioned above and can be used to produce cellular foamed materials of aromatic polyesters and polyester blends with fine, homogeneous, consistent and close cells on one hand. The preparation process comprising melt distributing multifunctional chain-extending compounds in the matrix of a carrier material at a temperature lower than the melting point of the multifunctional compounds containing chain-extending ingredients to produce the concentrate succeeds without any molecular branching and gel formation on the other hand.

The masterbatch is comprised of a polymer blend comprising a polar ethylene-acrylate copolymer and a high-temperature (HT) thermoplastic resin, a multifunctional compound comprising a chain-extending ingredient or a mixture of such ingredients.

The preparation process of the concentrate may comprise basically two steps: 1) Melt distributing the multifunctional compounds in form of powder or liquid and a HT thermoplastic resin in powder form in the matrix of the ethylene-acrylate copolymer at an internal mixer and 2) Further homogenizing and palletizing the molten mixture by using an extruder, preferably a single-screw extruder.

Before both preparation steps, the HT thermoplastic resin, in case of availability in form of granulates, needs to be grinded to powder to be used later in the mixing process, while the ethylene-acrylate copolymer in granulate shape is processed into melt matrix. In this invention, the particle size (according to DIN EN ISO 4610) of the HT polymer powder is less than 500 μm in average, preferably less than 200 μm, whereas at least 80 wt % of HT thermoplastic powder have a particle size less than 200 μm. Prior to further process steps, some HT thermoplastics needs to be dried at a defined temperature and time recommended by resin supplier to avoid a efficiency reduction of multifunctional compounds, as some of them are reactive to moisture. The drying temperature should be lower than the melting point or the reaction temperature of the multifunctional compound.

The temperature at which the multifunctional compound begins melting is defined as its melting point. The reaction temperature is the lowest temperature at which a chemical reaction of the multifunctional compound is initiated. The reaction temperature becomes preferential, if the multifunctional compound used in this invention is only available in form of liquid or its melting point is lower than 140° C.

In case of a multifunctional compound comprising only one ingredient, the melting point of this ingredient is thus the one of said multifunctional compound. If the multifunctional compound is comprised of a mixture of more than one ingredient, the melting point of the multifunctional compound is the one of an ingredient having the lowest melting point in comparison to other components in the multifunctional compound composition. The same definition is used for the reaction temperature of the multifunctional compound.

The HT thermoplastic powder and the multifunctional compound (mostly only available in form of powders with a particle size less than 200 μm) are then mixed by using a mixing apparatus at a rotating speed of 100-400 rpm.

Granulates of the ethylene-acrylate copolymer are added to a dispersion kneading/mixing device (Banbury mixer) comprising a mixing chamber in an 8-shape and two contra-rotating spiral-shaped blades encased in segments of cylindrical 8-shape housings. After softening of the ethylene-acrylate copolymer granulates (at about 40-50° C.), the mixture of the powders is added into the Banbury mixer. The powders are mixed, interspersed and compounded in the ethylene-acrylate resin system by using this internal mixer. The rotors may be cored for circulation of heating or cooling media, while the chamber can also be tempered with help of media. Due to an intensive friction between the granulates and the blades, the ethylene-acrylate experiences a shear stress and is molten by the shearing heat. The melt temperature, which is continuously monitored by measuring, can be influenced and controlled by the rotating speed of the rotors and additionally by the tempering medium within the blade core and/or at the chamber. The mixing process in the Banbury mixer is carried out so as to ensure melt temperatures at least 20° C., preferably at least 60° C. below the melting point or the reaction temperature of the multifunctional compound.

In addition, the melt temperature needs to be kept at least 20° C. below the glass transition temperature of amorphous HT thermoplastics or at 60° C. below the melting point of crystalline HT thermoplastic resin. In general, the process and melt temperatures remain in a range of 120-175° C. The further shearing of the mixture by blades rotating further distributes the unmolten powder components in the matrix of the molten ethylene-acrylate copolymer within a define time frame (generally about 4-8 min.) to ensure a relatively homogeneous mixture.

Subsequently, the compounded mixture is continuously fed into an extruder by a roll-mill heated at 80-100° C.: The roll-mill compresses first the mass to a sheet, followed by being sliced to strips and by feeding the mixture in form of strips into an extruder, preferably a single-screw extruder. The application of a single-screw extruder is preferred to easily control the throughput of the masterbatch by screw rotating speed. Another advantage of the single-screw extruder is connected with the fact of no or much less local overheating of thermoplastic materials by shearing in comparison to a twin-screw extruder. The extrusion of the mixture is implemented also at temperatures at least 20° C., preferably at least 60° C. either below the melting point or below the reaction temperature of the multifunctional compounds. In addition, the extrusion temperatures need to be kept at least 20° C. below the glass transition temperature of an amorphous HT thermoplastics or at least 60° C. below the melting point of a crystalline HT thermoplastic resin. In general, the extrusion step for preparation of the concentrate is implemented in a temperature range of 120-175° C. The mixture is further homogenized at the extruder and pelletized. The concentrate in form of granulates is cooled down and packed after a drying process. The high throughput capacity of a Banbury mixer enables the synchronization of a discontinuous interspersing/mixing process with a continuous extrusion pelletizing process.

Another embodiment of preparing said concentrates is to use a twin-screw extruder for melt blending the powder mixture of the multifunctional compound and the HT thermoplastic into the matrix of the ethylene-acrylate copolymer at temperatures at least 20° C., preferably at least 60° C. either below the melting point or below the reaction temperature of the multifunctional compound. In general, the extrusion preparation of the concentrate is implemented in a temperature range of 120-175° C. The mixture comprising the multifunctional ingredients and the HT polymer is preferably incorporated into the extruder by a side-feeder, while granulates of the ethylene-acrylate copolymer are added into the extruder through the hopper.

The advantages of this invention are described as follows:

In comparison to polyolefin, the ethylene-acrylate copolymers, comprising ethylene butyl acrylate (EBA), ethylene ethyl acrylate (EEA) and ethylene methyl acrylate (EMA) (s. Error! Reference source not found.), feature significantly better thermal and processing stability, even though their melting point is as low as 90-100° C.: EMAs for instance remain stable up to 350° C. in air and EEAs are stable over 400° C. in a nitrogen atmosphere. And the process temperature can be set up to 300° C. without degradation. More importantly, as a result of their high polarity, the ethylene-acrylate copolymers are not only compatible with polyolefin, but also with a broad range of engineering plastics such as PA, PBT, PET, ABS, PC or LCPs (Liquid Crystal Polymers) etc. The ethylene butyl acrylate resins (EBA) offer additionally excellent low-temperature toughness and impact resistance.

Acting as masterbatch carrier resins, the ethylene-acrylate copolymers demonstrate the same benefits as in their modifier role, i.e. general-purpose toughness, thermal stability, compatibility with engineering polymers and high filler acceptance. Moreover, according to current knowledge, they do not adversely affect the mechanical properties of engineering polymers to which they are added. The most important advantage of the current invention is that the low melting point (90-100° C.) and high thermal stability (up to 350-400° C.) of ethylene-acrylate copolymers can be beneficially exploited to prepare the invented concentrate at a low temperature and to foam aromatic polyester at a high temperature. Therefore, the chain-extending ingredients remain 100% unreacted during the preparation process and can be applied in a later foaming process at their full efficiency. An ethylene-acrylate copolymer in form of granulates is processed to obtain said concentrate without being milled before, in this invention. Last, but not least, resins of the ethylene-acrylate copolymers are classified as non-sticky pellets. An ethylene-acrylate copolymer comprising acrylate content by weight from 3 to 50% and featuring a melt-flow index from 0.1 to 50 g/10 min. at 190° C./2.16 kg (according to ISO 1133) is claimed as a component of the concentrate in the current invention.

A high-temperature (HT) thermoplastic acting as the blend partner in the carrier material composition of said concentrate having 1) a melting point not lower than 200° C. for crystalline or 2) a glass transition temperature not lower than 140° C. for amorphous polymers is introduced to give the masterbatch a much higher overall softening and melting point than one of an ethylene-acrylate copolymer, so that 1) the concentrate can be dried at a higher temperature than that for the concentrate described in WO 9509884 first of all and 2) problems of bridging and stickiness in feeder, hopper and extruder feeding zone can be diminished or eliminated. However, a selected HT thermoplastic resin must meet the requirement that said HT polymer is completely molten till 300° C. to prevent the foaming process from any inhomogeneous domains.

Even though the glass transition temperature of PMMA is about 110° C., so below 140° C., but this amorphous polymer can be exceptionally used as said HT thermoplastic in the concentrate composition, since the resin of PMMA is rigid.

Preferred use of aromatic polyester resin (including amorphous polyesters) such as PET, PBT, PTT, PEN or PBN can further improve the dispersion of the multifunctional chain-extending compounds in polyester melt. But, a selection of other HT thermoplastics such as PC, PA, PPO, PSU or PES is possible for this application, wherein polymer resins even incompatible with aromatic polyester resins are also candidate for this masterbatch, because the ethylene-acrylate copolymer is compatible with the aromatic polyesters and acts as a coupling material. Moreover, a HT thermoplastic resin can be chosen to improve some properties such as ductility, coupling function or conductivity of final cellular foams of aromatic polyester. Therefore, a wide range of available/usable HT thermoplastics or a mixture thereof is another advantage in the current invention. The mostly preferred HT thermoplastic resin is an aromatic polyester selected from PET, PBT and PEN (IV=0.4-1.4 dl/g according to ASTM 4603).

Application of said polymer blend as carrier material comprising the ethylene-acrylate copolymer and a HT thermoplastic/mixture of HT thermoplastic resins assures that no polymer degradation occurs not only at the preparation, but also at the subsequent foaming process. The most important advantage of this invention can be seen in an uniform distribution and a full dispersion of the multifunctional compound during the foaming process, as they are encapsulated in at least the ethylene-acrylate copolymer, which is fully compatible with aromatic polyester melt.

Instead of the ethylene-acrylate copolymer, an ethylene-vinylacetate (EVA) copolymer can be also used as the blend partner of the carrier material in the concentrate composition due to the low melting point, the good compatibility and filler acceptance of this copolymer. But the thermal resistance of EVA is not as superior as the ethylene-acrylate copolymers.

The multifunctional compounds used in the current invention are comprised of one or more chain-extending/branching ingredients having either a melting point or a reaction temperature higher than 140° C., preferably selected from a group consisting of tetracarboxylic dianhydride, polyepoxides, oxazolines, oxazines, acyllactams and antioxidant comprising sterically hindered phenolic end groups or mixtures thereof.

The most important multifunctional chain-extending compound used in this invention comprises tetra or polycarboxylic dianhydride in amount from 2 to 30 percent, preferably from 5 to 15 percent by weight of the concentrate and selected from a group containing at least two anhydride per molecule such as pyromellitic dianhydride, benzophenone dianhydride, 2,2-bis (3,4-dicarboxyphenyl) propane dianhydride, 3,3′,4,4′-biphenyltetracarboxylic acid dianhydride, bis(3,4-dicarboxyphenyl)ether dianhydride, bis(3,4-dicarboxyphenyl) thioether dianhydride, bisphenol A bisether dianhydride, 2,2-bis(3,4-dicarboxylphenyl) hexafluoropropane dianhydride, 2,3,6,7-naphtalene-tetracarboxylic acid dianhydride, bis(3,4-dicarboxyphenyl) sulfone dianhydride, 1,2,5,6-naphthalene-tetracarvoxylic acid dianhydride, 2,2′,3,3′-biphenyltetracarvoxylic acid dianhydride, hydroquinone bisether dianhydride, bis(3,4-dicarboxyphenyl) sulfoxide dianhydride, 3,4,9,10-perylene tetracarboxylic acid dianhydride and blends thereof.

Preferred tetracarboxylic dianhydrides are those containing aromatic rings.

Particularly preferred tetracarboxylic dianhydrides are pyromellitic dianhydride, 3,3′,4,4′benzophenonetetracarboxylic acid dianhydride and mixtures thereof. The most preferred tetracarboxylic dianhydride is pyromellitic dianhydride (PMDA). Another important multifunctional compound is polyepoxides having at least two epoxy groups per molecule. Typical polyepoxides are diepoxy compounds, ethylene glycol diglycidyl ether, polyethylene glycol diglycidyl ether, propylene glycol diglycidyl ether, polypropylene glycol diglycidyl ether, polytetramethylene glycol diglycidyl ether, glycerol diglycidyl ether, diglycidyl phthalate, diglycidyl terephthalate, dicyclopentadiene diepoxide, 3,4-epoxy-6-methylcyclohexyl-3,4-epoxy-6-methylcyclohexanecarboxylate, 3,4-epoxycyclohexyl-3,4-epoxycyclohexanecarboxylate and vinylcyclohexane diepoxide etc. Particularly preferred are solid polyepoxides of the diglycidyl ether of bisphenol A type such as 4-[2-(4-hydroxyphenyl)propan-2-yl]phenol, which has a melting point of 150-152° C.

In EP08016250, it has been found that the antioxidant comprising sterically hindered phenolic end groups in combination with a tetracarboxylic dianhydride leads to a significant increase of molecular weight of polyester during the heating and mixing process, since such a mixture also enhanced the extensional viscosity of polyester remarkably. Therefore, a primary antioxidant such as sterically hindered phenolic antioxidant: 4-((3,5-bis((4-hydroxy-3,5-ditert-butyl-phenyl)methyl)-2,4,6-trimethyl-phenyl)methyl)-2,6-ditert-butyl-phenol, sterically hindered hydroxyphenylalkylphosphonic acid ester or half ester is also applied in combination with tetracarboxylicdianhydrides in the current invention.

Beside above mentioned antioxidants, particularly suitable sterically hindered phenolic antioxidants selected from the group of so-called primary antioxidants include for instance: Pentaerythritol tetrakis (3-(3,5-di-tert-butyl-4-hydroxyphenyl)propionate), thiodiethylene bis[3-(3,5-di-tert-butyl-4-hydroxyphenyl)propionate], octadecyl-3-(3,5-di-tert.butyl-4-hydroxyphenyl)-propionate, N,N′-hexane-1,6-diylbis(3-(3,5-di-tert-butyl-4-hydroxyphenylpropionamide)), 1,3,5-tris(3,5-di-tert-butyl-4-hydroxybenzyl)-1,3,5-triazine-2,4,6(1H,3H,5H)-trione.

Particularly preferred sterically hindered phenolic antioxidant is selected from hydroxyphenyle propionate and hydrobenzyl groups such as: 4-((3,5-bis((4-hydroxy-3,5-ditert-butyl-phenyl)methyl)-2,4,6-trimethyl-phenyl)methyl)-2,6-ditert-butyl-phenol or calcium bis(monoethyl(3,5-di-tert-butyl-4-hydroxylbenzyl)phosphonate).

Furthermore, an oxazoline for further improvement of foamability of the polyesters can also be composed in the recipe of the multifunctional compound comprising mixture of sterically hindered phenolic antioxidant and tetracarboxylic dianhydride. Mixtures of different oxazoline can be applied in the concentrate recipes. Preferred oxazoline is the monooxazoline for instance 2-, 3- or 4-oxazoline as well as bisoxazoline. Particularly preferred bisoxazoline is 1,3-phenyl bisoxazoline and 1,4-phenyl bisoxazoline. Trioxazoline can be alternatively integrated into the recipe of said concentrates.

The current invention relates thus to the preparation and application of concentrates comprising 2-30 wt %, preferably 10-15 wt % of multifunctional compounds. The carrier material used in the masterbatch comprises 10-85 wt % (by weight of the concentrate) ethylene-acrylate copolymer and 10-85 wt % (by weight of the concentrate) HT thermoplastics. Preferably, the ethylene-acrylate copolymer and the HT thermoplastics are applied each in amount from 30 to 60 wt % by weight of the concentrate.

In the reactive extrusion processes to produce low density cellular foams, an amount of concentrate from 1 to 20%, preferably between 1 and 10% by weight of the mixture comprising concentrate and the polyester resin is applied, wherein an extrusion line is preferred, which may comprise basically of an extruder, die, dosing equipment, gas injector, heat exchanger, static mixer and die. The extrusion line is followed by downstream equipment such as puller, conveying rolls with air cooling, sawing unit, further cooling and grinding and packaging etc. All types of foaming extruders can be used for the reactive foam extrusion in the current invention: single-screw or co-/counter-rotating twin-screw extruder, tandem extrusion line comprising a primary extruder (twin- or single-screw extruder) and a secondary/cooling single-screw extruder.

The blowing agents required for expansion are generally selected from carbon dioxide, nitrogen, alcohols, ketons, hydrocarbons, fluorohydrdocarbons or mixture thereof. The concentrate can contain additionally further additives such as process/thermal stabilizers, nucleating agents, UV stabilizers and flame retardants etc. in the recipes. Representative flame retardants are for example halogenated, charforming (like phosphorus-containing) or water-releasing compounds, charforming and water-releasing (like Zn borate) compounds. Commonly used nucleate types are talc, TiO₂, MgO, BaSO₄, SiO₂, Al₂O₃, CdO, ZnO, mica fuller's earth, diatomaceous earth or the like.

The application of said concentrates can be seen in all thermoplastic polymer processes (e.g. blow molding, batch process, injection molding or sheet extrusion for thermoforming), but focuses mainly on reactive foam extrusion to process a wide range of aromatic polyesters. The process for foaming aromatic polyesters is generally foam extrusion, wherein profile, annular, multihole and flat die can be applied to form an extrudate into a required final shape.

Preferred aromatic polyesters for production of final cellular foamed products include those derived from terephthalic acid, isophthalic acid, naphthalenedicarboxylic acid, cyclohexanedicarboxylic acid and the like or the alkyl esters. Particularly preferred is DMT- or PTA-based PET with I.V.=about 0.4-1.4 dl/g (according to ASTM 4603) including homo- and copolymer. Alternatively, polyester blends comprised of polyester/polyolefin (e.g. PET/LLDPE, PET/LDPE or PET/PP), polyester/polyester (PET/PBT, PET/PEN, PET/PC), polyester/styrene copolymer (PET/SAN, PET/SEBS), polyester/high temperature thermoplastics etc. can be processed with help of the invented concentrates.

### EXAMPLES OF THE INVENTION

This invention is illustrated by the following examples given for illustrative purpose and not to be regarded as limiting the invention or the manner in which it can be practiced.

### Example 1

46.5 weight parts of PET copolymer granules (I.V.=0.76 dl/g) were milled to powder having at least 80 wt % particles less than 200 μm and dried at 165° C. for 8 h. The PET powder was mixed with 12 weight parts PMDA and 0.15 weight parts Irganox B900 in a mixer.

41.35 weight parts of Elvaloy 1820 (DuPont) were first added to a 5000 cm³ Banbury mixer. After the ethylene-acrylate copolymer is softened at 40-50° C., the mixture of above powders was added to mixer for being mixed and blended with Elvaloy 1820 at 30-40 rpm for 4-7 minutes. The rotating speed of the mixer was adjusted to ensure a melt temperature between 160-170° C. The compound was fed to a roll mill heated at 80-100° C. and pressed to a thin sheet. The sheet was sliced to strips, followed by continuously feeding the mixture in form of strips into a single-screw extruder (φ45 mm/30D). The mixture was extruded through a strand die. The strands were cooled down in a water bath, pelletized and dried immediately in a dryer.

The process parameters were:

Extruder: Single-screw extruder with 45 mm diameter and 30D length

Speed of the screw: 70-120 rpm

Barrel temperatures: 100-165° C.

Die temperature: 165° C.

Throughput: 30-35 kg/h.

The prepared concentrate was then packed and sealed in a bag coated with aluminum.

### Example 2

The procedure of Example 1 was repeated with the difference that 2.5 weight parts of Irganox 1330 were added, 10 instead of 12 weight parts of PMDA and 40.85 instead of 41.35 weight parts of Elvaloy 1820 were used for the preparation process.

### Example 3

The procedure of Example 2 was repeated with the difference that 1.5 weight parts of 1,3 PBO (from Evonik) were added and 8.5 instead of 10 weight parts of PMDA were applied. After the PET powder was dried at 110° C. for at least 10 h instead 165° C. for 8 h, this powder was added into the Banbury mixer. A further difference is seen in the melt temperature in the Banbury mixer and the single-screw extruder. In Example 3, the Banbury mixer was run at a lower rotating speed than in Example 2 to have a melt temperature at 120-125° C. The extruder was set at the temperatures:

Barrel temperatures: 100-125° C.

Die temperature: 125° C.

### Example 4

The procedure of Example 1 was repeated with the difference that 46.5 weight parts of Ultrason E 2020 SR micro (supplied by BASF in form of powder having particle size <100 μm) instead of PET were used at the preparation process. The drying condition for PES resin was as same as for PET.

### Example 5

PET copolymer (I.V.=0.78 dl/g) was dried at 170° C. for 8 h and the concentrate of Example 1 at 80° C. for 8 h. a). The PET resin with 3.4% of the concentrate and effectively 0.65% of a nucleating agent each by weight of the total throughput was continuously extruded and foamed at a throughput of 350-400 kg/h with help of a co-rotating twin-screw extruder BC180 (φ180 mm/L/D=28 and made by BC Foam), whereas CO₂ as blowing agent was injected into the extruder at a rate of 3.5 kg/h. The twin-screw extruder was attached with a static mixer, the extrusion tooling (strand die) comprised a divergent adapter and a multihole plate. The foamed extrudate was formed in a calibrator and cooled down. The temperature setting of the extruder can be seen in Tab. 2:

TABLE 2
Temperature setting

| Feature | Setting |
|---|---|
| Temperature of feeding zone (° C.) | 120-220 |
| Temperature of melting zone (° C.) | 280-290 |
| Temperature of metering zone (° C.) | 255-275 |
| Temperature of static mixer (° C.) | 210-255 |
| Temperature of strand die (° C.) | 270-290 |

The foamed extrudate showing a thickness of 60-68 mm was further cooled down by air and pulled to a sawing unit to be cut.

The extrusion process was very stable and an extruded PET foam with a fine and uniform cell structure was obtained, whereas the foam density was 158 kg/m³. The results from a compression testing showed a strength of 2.5 MPa and a modulus of 92 MPa (according to ISO 844).

### Example 6

The foam extrusion of Example 5 was repeated with the difference that the concentrate of Example 2 instead of Example 1 was used and cyclopentane at a rate of 8-9 kg/h instead of CO₂ was injected into the extruder.

The extrusion process was very stable and an extruded PET foam with a fine and uniform cell structure was obtained at a foam density of 110 kg/m³. The results from a compression testing showed a strength of 1.65 MPa and a modulus of 74 MPa (according to ISO 844).

### Example 7

The foam extrusion of Example 6 was repeated with the difference that 1) the concentrate of Example 3 instead of Example 2 was used and 2) cyclopentane at a rate of 10-11 kg/h was injected into the extruder.

The extrusion process was very stable and an extruded PET foam with a fine and uniform cell structure was obtained at a foam density of 81 kg/m³. The results from a compression testing showed a strength of 1.20 MPa and a modulus of 32 MPa (according to ISO 844).

### Example 8

In this example, a co-rotating twin screw extruder (FG75 manufactured by Fagerdala) having a screw diameter of φ75 mm and L/D=32, followed by a static mixer and a strand die, was applied. The forming tooling was a strand die comprised of 74 orifices distributed on the exit area of 67.5×35.5 mm. The foam extrudate underwent a calibration after leaving the strand die to be shaped to a rectangular board.

PET copolymer (I.V.=0.78 dl/g) was dried at 165° C. for 8 h and the concentrate of Example 4 at 80° C. for 8 h. a). The PET resin with 3.4% of the concentrate and effectively 0.65% of a nucleating agent each by weight of the total throughput was continuously extruded and foamed at a throughput of 45 kg/h. The PET resin and the concentrates were separately fed into the twin screw extruder by individual dosing units. The mixture was extruded and a foaming took place with help of n-pentane as blowing agent. The process parameters are listed in Tab. 3:

TABLE 3
Process parameters

| Feature | Parameter |
|---|---|
| Temperature of feeding zone (° C.) | 120-260 |
| Temperature of melting zone (° C.) | 280-285 |
| Temperature of metering zone (° C.) | 275-280 |
| Temperature of static mixer (° C.) | 275-285 |
| Temperature of die (° C.) | 285-290 |
| Melt throughput (kg/h) | 45 |
| Gas injection (g/min) | 17.5 |

The extrusion process was very stable and a produced PET foam with a fine and uniform cell structure was obtained at a foam density of 115 kg/m³.

### Example 9

The foam extrusion of Example 8 was repeated with the difference that 1) the concentrate of Example 3 in amount of 5.5% instead of 3.4% Example 4 was used all by weight of the total throughput and 2) a low-viscous PET copolymer (I.V.=0.60 dl/g) was foamed.

The extrusion process was very stable and an extruded PET foam with a fine and uniform cell structure was obtained at a foam density of 115 kg/m³.

1. A concentrate (masterbatch) useful as chain-extending/branching agent comprising an ethylene-acrylate copolymer, a high-temperature (HT) thermoplastic resin and a multifunctional compound selected from of one or more chain-extending/branching ingredients having either a melting point or a reaction temperature higher than 140° C.

2. The concentrate according to claim 1, wherein the multifunctional compound is preferably selected from a group consisting of tetracarboxylic dianhydride, polyepoxides, oxazolines, oxazines, acyllactams and antioxidant containing sterically hindered phenolic end groups or mixtures thereof.

3. The concentrate according to claim 1 comprising 10 to 85 weight percent, preferably 30 to 60 weight percent of the ethylene-acrylate copolymer which is selected from ethylene butyl acrylate (EBA), ethylene ethyl acrylate (EEA) and ethylene methyl acrylate (EMA) copolymer.

4. The concentrate according to claim 3, wherein the ethylene-acrylate copolymer preferably contains 3 to 50 percent of acrylate content by weight of the ethylene-acrylate copolymer and has a melt-flow index from 0.1 to 50 g/10 min. at 190° C./2.16 kg.

5. The concentrate according to claim 1 comprising 10 to 85 weight percent, preferably 30 to 60 weight percent of the high-temperature (HT) thermoplastic which is selected from one of thermoplastic resins or mixtures thereof having 1) a melting point not lower than 200° C. for crystalline polymer or 2) a glass transition temperature not lower than 140° C. for amorphous polymers. In addition, the HT thermoplastics need to be completely molten up to 300° C.

6. The concentrate according to claim 5, wherein the preferred high-temperature thermoplastics are aromatic polyesters, particularly preferably PET, PBT or PEN having an intrinsic viscosity of 0.4 to 1.4 dl/g.

7. The concentrate according to claim 1 comprising 2 to 30 percent, preferably 10 to 15 percent of the multifunctional compound by weight of the concentrate.

8. The concentrate according to claim 7 comprising the multifunctional compound very preferably selected from a tetracarboxylic dianhydride with 2 or more acid anhydride groups per molecule, most preferably from a pyromellitic dianhydride (PMDA), in amount of 2 to 30 percent, preferably from 5 to 15 percent by weight of the concentrate.

9. The concentrate according to claim 8 further comprising 0.1 to 10 weight percent, preferably 0.5 to 5 weight percent of a sterically hindered phenolic antioxidant.

10. The concentrate according to claim 9 further comprising 0.1 to 10 weight percent, preferably 0.5 to 5 weight percent of an oxazoline.

11. The concentrate according to claim 9, wherein the sterically hindered phenolic antioxidant is calcium bis(monoethyl(3,5-di-tert-butyl-4-hydroxylbenzyl)phosphonate) (Irgamod 195) or 4-((3,5-bis((4-hydroxy-3,5-ditert-butyl-phenyl)methyl)-2,4,6-trimethyl-phenyl)methyl)-2,6-ditert-butyl-phenol (Irganox 1330, Ethanox 330 or Alvinox 100).

12. The concentrate according to claim 10, wherein the oxazoline is a monooxazoline or bisoxazoline or trioxazoline or a mixture thereof. The particularly preferred bisoxazoline is selected from
a. 1,3-phenyl bisoxazoline (1,3 PBO) and
b. 1,4-phenyl bisoxazoline (1,4 PBO).

13. The concentrate according to claim 1, wherein the multifunctional compound is a polyepoxide having at least two epoxy groups per molecule, preferably selected from diglycidyl ethers of biphenol A type.

14. The concentrate according to claim 1 further comprising a thermal and/or process stabilizer selected from a secondary (preventive) antioxidant or a mixture of the secondary antioxidant and sterically hindered phenols in amount of 0.1 to 5.0 percent by weight of the concentrate.

15. A process for the preparation of the concentrate according to claim 1, wherein the HT thermoplastic resin and the multifunctional compound all in form of powder are blended and homogeneously mixed into the matrix of the ethylene-acrylate copolymer at temperatures at least 20° C., preferably at least 60° C. below the melting point or the reaction temperature of the multifunctional compound and by using an internal mixer such as a Banbury mixer, an extruder or any similar polymer processing equipment.

16. The process for the preparation of the concentrate according to claim 15, wherein the mixture from the internal mixer is continuously fed into an extruder, preferably a single-screw extruder, and extruded at temperatures at least 20° C., preferably at least 60° C. below the melting point or the reaction temperature of the multifunctional compound.

17. A process for the preparation of the concentrate according to claim 1 comprising melt blending the mixture of the multifunctional compound and the HT thermoplastic into the melt of the ethylene-acrylate copolymer by using an extruder, preferably a twin-screw extruder at temperatures at least 20° C., preferably at least 60° C. below the melting point or the reaction temperature of the multifunctional compound.

18. The process for the preparation of the concentrate according to claim 15, wherein the concentrate composition is processed preferably at temperatures between 120° C. and 175° C.

19. A foaming process for production of a foamed cellular material of aromatic polyesters, wherein the polyester resins selected from a group consisting of virgin, recycled resin or a mixture thereof having an intrinsic viscosity from 0.4 to 1.4 dl/g are foamed with help of the concentrate of claim 1 in amount from 1 to 20 percent, preferably from 1 to 10 percent by weight of the mixture.

20. A foamed cellular material obtainable according to claim 19.

21. Articles containing the foamed material of claim 20.
